(19) United States
(12) Patent Application Publication
(10) Pub. No.: US 2015/0167709 A1
(43) Pub. Date: Jun. 18, 2015

(54) Installation Initiated Bolt Capturing Compression Limiter

(71) Applicant: Spirol International Corporation, Danielson, CT (US)

(72) Inventor: Thomas J. Buchta, Cottam (CA)

(73) Assignee: Spirol International Corporation, Danielson, CT (US)

(21) Appl. No.: 14/105,726

(22) Filed: Dec. 13, 2013

(51) Int. Cl. F16B 5/02; F16B 43/00

(52) U.S. Cl. CPC F16B 5/02; F16B 43/00

(57) ABSTRACT

A one-piece compression limiter that is simple to manufacture and install with a bolt or having a head, a smooth shank portion, and an enlarged lead portion including threads. The limiter and bolt can be supplied separately. At the time of installation into the though hole of a component, the limiter is first advanced with clearance along the lead portion toward the head into a loose position around the shank. The bolt is then aligned within the hole and the head is pushed to urge the remainder of the bolt and limiter into the hole together such that the wall of the hole compresses the limiter radially inwardly into close proximity to the shank, thereby trapping the limiter between the head and lead portion of the bolt. The disclosed limiter is a cylindrical tube with a longitudinal slit and a plurality of inwardly projecting dimples.

### BACKGROUND

The present invention relates to fasteners, and particularly to compression limiters for bolts and the like.

A compression limiter is an engineered fastener designed to limit the columnar load exerted by a threaded fastener on a plastic or other relatively soft component. Such compression limiters also have the added function of limiting the distance a bolt can move within the limiter, when both the bolt and limiter are installed into the recommended hole in a molded plastic component. When installed, the bolt can move to allow ease of installation of the entire assembly, but cannot fall out of the compression limiter.

Compression limiters of the type of interest are typically made of metal and have an effective length that is approximately the same as the thickness of the component, such that excessive torque applied to the fastener imposes the columnar axial load on the metal limiter rather than on the surrounding, more pliable or deformable plastic component.

Although many types of compressing limiters are known, they generally require that the compression limiter be crimped or otherwise secured onto the shank portion of the bolt before the bolt and limiter are inserted into the hole of the component. Many limiter configurations require a fitting to be installed in the hole, in addition to a sleeve or the like on the bolt.

### SUMMARY

It is object of the present invention to provide a one-piece, tubular compression limiter that is simple to manufacture and install with a bolt or the like having a head, a smooth shank portion, and an enlarged lead portion including threads.

This is achieved with a limiter that can be advanced along the lead portion to a loose position around the shank of the bolt, followed by pushing the bolt and limiter into the hole together such that the wall of the hole compresses the limiter radially inwardly into close proximity to the shank, thereby trapping the limiter between the head and lead portion of the bolt.

With the shank portion of uniform diameter Ds and the lead portion having a maximum diameter Dm, the limiter comprises a tubular sleeve having a substantially cylindrical wall extending between first and second ends with outside diameter D1 and inside diameter D2>Dm; weakened regions of the wall located such that the wall can be circumferentially compressed radially inwardly when inserted into a round hole having a diameter Dh<D1; and at least one projection extending radially inwardly from the wall and defining a minimum effective diameter D3, where Ds<Dm<D3<D2 before installation.

The corresponding method for installing and capturing a fastener within a compression limiter mounted in the hole of a component, comprises selecting a compression limiter in the form of a tubular sleeve having a substantially cylindrical wall extending between first and second ends; sliding the sleeve over the leading portion of the fastener onto the shank; inserting the leading portion of the fastener into the hole; urging the head of the fastener against the sleeve and thereby driving the sleeve into the hole and mounting the sleeve within the hole by radially inwardly compressing the sleeve; whereby compressing the sleeve as the sleeve is driven into the hole pushes the projections on the inside of the sleeve toward the shank and establishes an effective diameter of the projections at the shank that is smaller than the diameter of the lead portion of the fastener.

The invention allows for the limiters and bolts to be purchased, shipped and stored separately until the point of installation. At the point of installation, a limiter is first slid onto a bolt to form a stand-alone sub-assembly, and then the sub-assembly is forced into the hole of the component. The bolt is captured by the limiter, only after the sub-assembly is installed in the component.

### BRIEF DESCRIPTION OF THE DRAWING

An embodiment of the invention will be described with reference to the accompanying drawing, in which:

FIG. 1 shows a type of fastener which is useable with the present invention;

FIG. 2 is an elevation view of the compression limiter according to an embodiment of the invention;

FIG. 3 is an end view, taken from the right, of the compression limiter of FIG. 2;

FIG. 4 is a cross-section view of the compression limiter, taken along line 4-4 of FIG. 2;

FIG. 5 shows the compression limiter of FIG. 2 as a sleeve which, in the neutral condition, is freely slideable along the entire length of the bolt, toward the head of the bolt;

FIG. 6 shows the installed condition of the compression limiter and captured bolt, with maximum penetration through a hole in a component; and

FIG. 7 is similar to FIG. 6, but showing the maximum withdrawn of the bolt as captured in the compression limiter.

### DETAILED DESCRIPTION

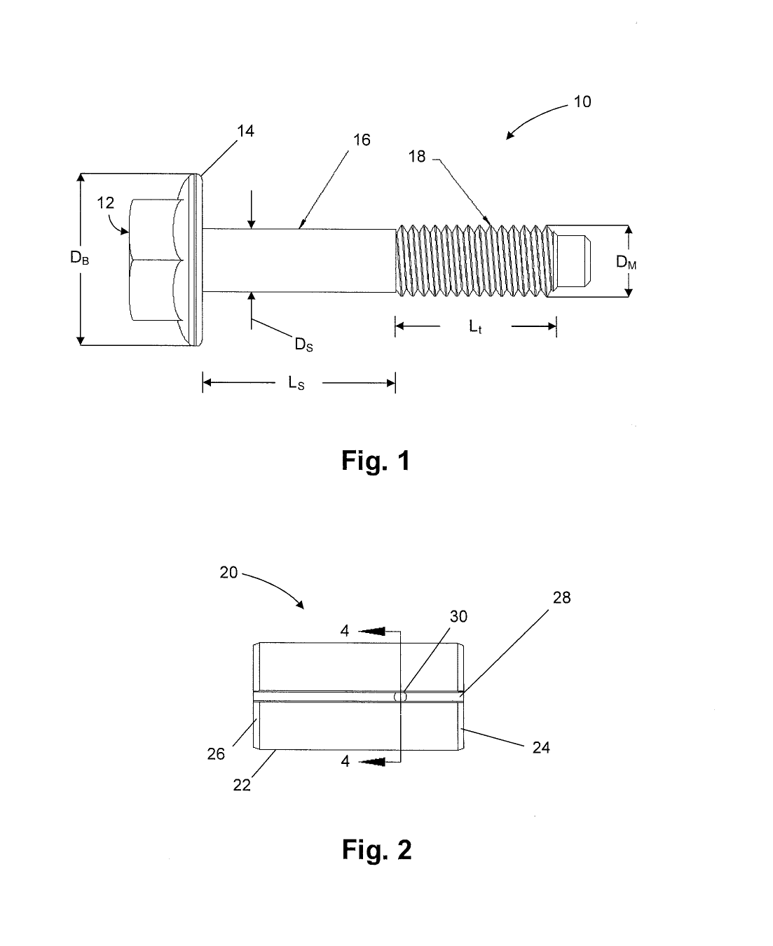

With reference to FIG. 1, a typical fastener would be a bolt 10 having a head 12 including a base or flange 14, a shank 16 having a substantially smooth, uniform diameter Dₛ, and a lead portion 18 that is threaded over a length Lₜ. The threads (or in some cases a rim or the like at the interface with the shank) has a maximum diameter Dₘ which is larger than Dₛ. The length Lₛ of the shank portion 16 defines the possible travel distance of the bolt 10 when installed into a host component, such as a plastic part to be secured to a metal housing or the like.

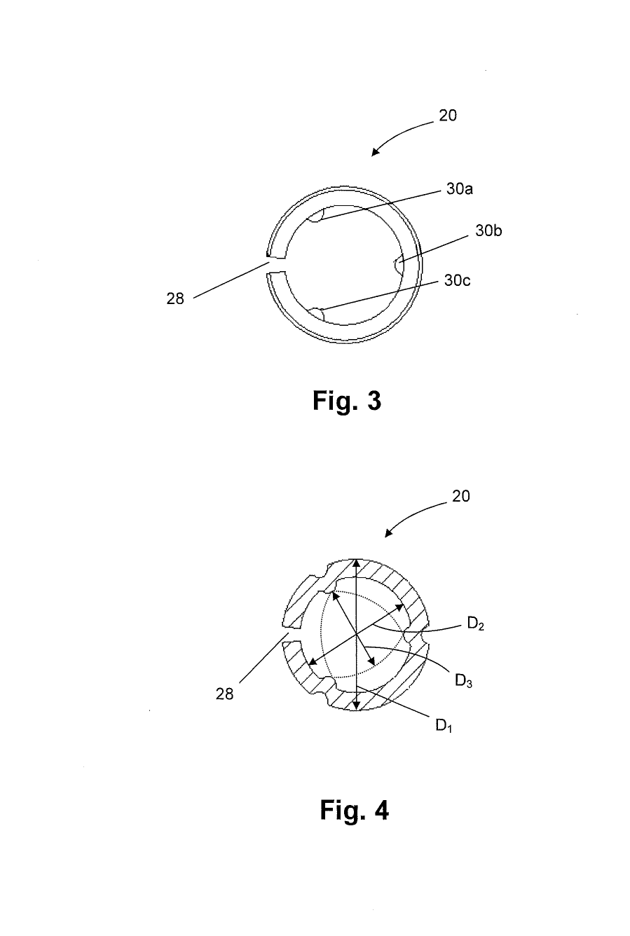

The compression limiter 20 is shown in FIGS. 2, 3 and 4. The compression limiter 20 is a hollow tubular cylinder 22 having a first end 24 and a second end 26, preferably with a longitudinal slit 28 extending between the ends. The limiter 20 has an outside diameter D1 and an inside diameter D2. However, at least one projection or protrusion 30 defines an effective diameter D3 that is smaller than the inside diameter D2. Preferably, these projections are in the form of three dimples, 30A, 30B, 30C at the same axial position along the length of the sleeve. These dimples can readily be formed during manufacture of the limiter by deformation from localized pressure at the outside of the cylinder or cylinder preform. The longitudinal slit 28 is provided as a means for permitting the cylinder to be radially inwardly compressed during installation of the bolt and limiter together as will be described more fully below. It should be appreciated that other techniques for providing weakened regions in the cylinder can be effective to accommodate such radial compression. The dimensions indicated with respect to FIGS. 2-4 are for the free or neutral condition, prior to installation into a component to be fastened.

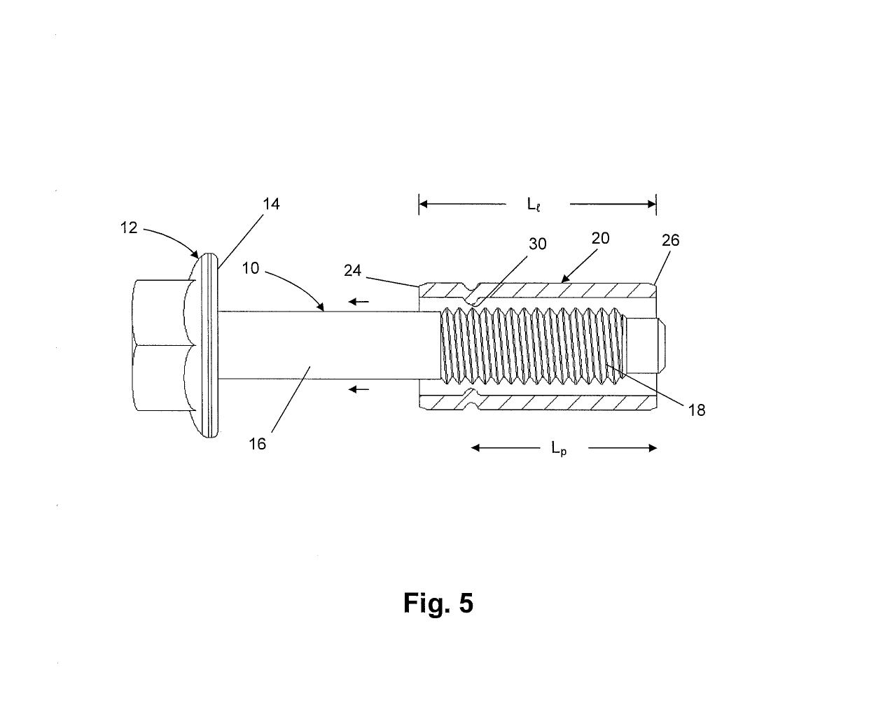

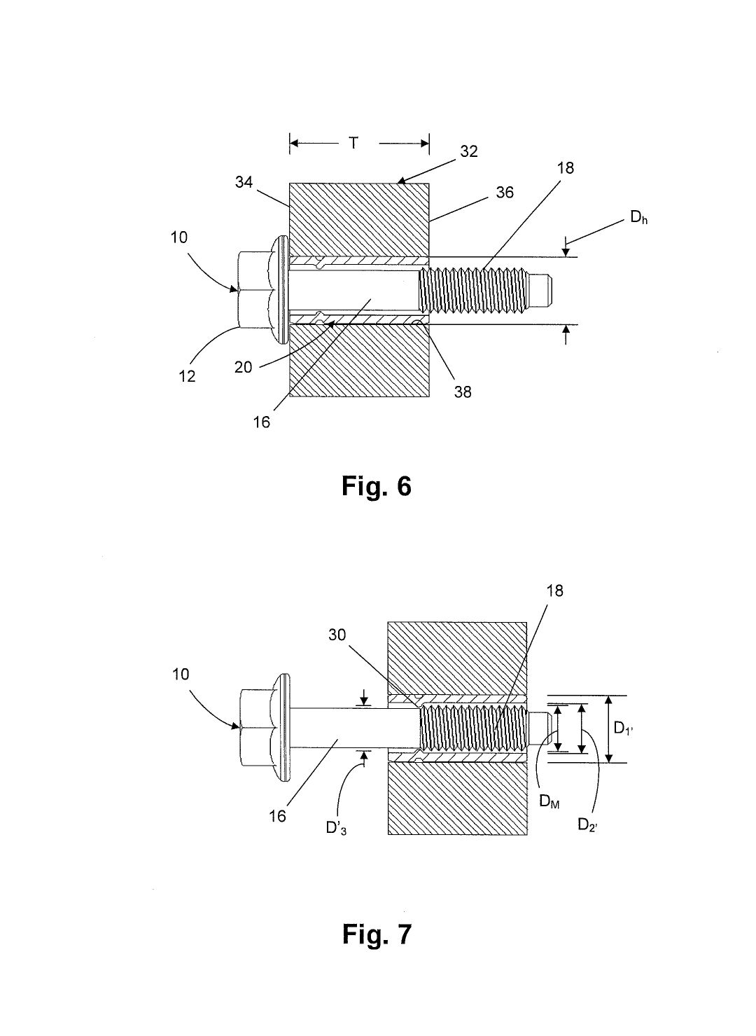

FIG. 5 shows the first step in preparing to install the bolt 10 with limiter 20, into a component indicated at 32 in FIGS. 6 and 7. The cylinder 20 is passed over the leading portion 18 of the bolt 10 toward the head 12 at least until the projections 30 are at the shank 16. preferably, in this manner, the cylinder 20 is can be considered as a sleeve. The limiter 20 has an overall length Lₗ between ends 24 and 26, with the length Lₚ indicating the distance from the second end 26 to the projections 30. With the first end 24 of the sleeve abutting the base 14 of the head, the leading end 18 of the bolt is aligned within the hole 38 in component 32, while the shank and sleeve remain outside the hole. The hole has a diameter Dₕ. This is smaller than the neutral outside diameter D₁ of the sleeve 20, but larger than the maximum diameter Dₘ of the leading end 18 of the bolt. The chamfered leading end 26 of the sleeve 20 enters the hole 38 and passes from one side 34 to the other side 36 of the component 32 as a result of an installation force applied axially on the head of the bolt such that the base 14 urges the sleeve 20 through hole 38, thereby compressing the sleeve radially inward until the sleeve 20 is fully installed into the component as shown in FIG. 6.

Because the projections 30 were along the axial length of the shank 16 while the head 12 was pushing the sleeve 20 through hole 38, the compression of the sleeve reduces the diameters associated with the sleeve 20. FIG. 7 shows that in the installed condition, the outside diameter D₁′ of the sleeve is equal to the diameter Dₕ of the hole 38; the effective inside diameter D₂′ of the sleeve remains larger than the maximum diameter Dₘ of the lead portion 18 of the bolt, and the effective diameter D₃′ at the projections 30 is smaller than the diameter Dₘ of the leading portion.

These relationships permit the bolt 10 to freely travel between the conditions shown in FIGS. 6 and 7. As shown in FIG. 6, the bolt travel in the direction of the leading portion 18 is limited by contact between the head 12 and one side 34 of the component 32, whereas bolt travel is limited in the direction toward the head by contact between the first thread adjacent the shank in the threaded portion 18 and the projections 30. With further reference to FIG. 5, the overall length Lₗ of the sleeve 20 is the same as or differs by less than about +/−3% from the thickness T of the component 32 and the length of Lₚ between the projections 30 and the second end 26 of the sleeve is substantially the same as the length of the threaded portion 18 of the bolt.

In the radially compressed condition shown in FIGS. 6 and 7, the sleeve 20 will attempt to recover its free-state diameter, which will exert a radially outward force into the wall of the component defining the hole. This provides strong retention of the sleeve in the installed condition.

It should thus be appreciated that the unitary compression limiter is amenable to simple manufacturing and installation techniques yet simultaneously achieves the triple functionality during installation in a component of (i) securing the limiter within the hole; (ii) capturing the bolt; and (iii) protecting the component.

A multiplicity of compression limiters can be shipped together without any associated fasteners, and likewise a multiplicity of fasteners can be shipped separately from the limiters, with an individual limiter being combined with an individual bolt at the moment of installation into the hole of a component. This avoids the step required in some prior art, where a compression limiting sleeve is installed on the bolt before the bolt is shipped. It also avoids the step in some prior art, whereby a separate fitting must be placed in the hole of the component for interaction with a sleeve or the like on the bolt. With the present invention, virtually no extra steps are required, other than what an installer would normally do by passing a bolt into the raw hole of the component.

Thus, in one novel aspect, the invention is directed to a compression limiter apart from a fastener but dimensioned in relation to a fastener with which it is to be utilized. For a fastener with a shank portion of diameter Dₛ and a thread or other maximum diameter Dₘ the compression limiter is a tubular sleeve having an outside diameter D1 and an inside diameter D2 greater than Dₘ. The outside diameter D1 is selected to be larger than the diameter Dₕ of the hole into which it is earmarked for installation so that the sleeve collapses radially during installation. In the neutral condition, standing alone, the compression limiter has internal projections defining a minimum effective diameter D3, where Dₛ<Dₘ<D₃<D₂. To assure unobstructed operation according to the foregoing description, the diameter difference (D₁−Dₕ) >(D₃−Dₘ).

Another novel aspect of the present invention is the combination of a fastener and paired compression limiter, for example, when a container of fasteners and a container of compression limiters are at the same location to be used together according to the foregoing description. In the free state, the compression limiter has no effect on the bolt. This method allows for the limiter and bolt to be purchased, shipped and stored separately until the point of installation. Only at that time will the entire assembly function as a captive bolt limiter.

In yet another aspect, the invention is directed to the assembled combination as shown in FIGS. 6 and 7 for installing as described. With additional reference to FIG. 1, the base of the head has a diameter D_{b} such that Dₛ<Dₘ<D_{b}. The outside diameter D₁′ of the compressed sleeve wall is at the inside of the diameter Dₕ of the hole, the inside diameter D₂′ of the compressed sleeve wall is greater than Dₘ, and at least one projection extends radially inwardly from the sleeve wall at the shank with an effective diameter D₃′ less than Dₘ. The bottom of the head at diameter D_{b} is greater than or equal to the inside diameter D₂′ of the compressed sleeve, preventing the fastener from passing entirely through the sleeve in the direction toward the lead portion of the fastener, and the at least one projection at effective diameter D₃′ less than Dₘ prevents the fastener from passing entirely through the sleeve in the direction toward the head.

1. A compression limiter for a fastener having a head, a shank portion of uniform diameter Ds extending from the head and a lead portion including threads extending from the shank and having a maximum diameter Dm, comprising:
a tubular sleeve having a substantially cylindrical wall extending between first and second ends with outside diameter D1 and inside diameter D2>Dm;
weakened regions of the wall located such that the wall can be circumferentially compressed radially inwardly when inserted into a round hole having a diameter Dh<D1; and
at least one projection extending radially inwardly from the wall and defining a minimum effective diameter D3, where Ds<Dm<D3<D2.

2. The compression limiter of claim 1, wherein the weakened region is a longitudinal slit.

3. The compression limiter of claim 1, wherein the at least one projection is a plurality of opposed dimples.

4. The compression limiter of claim 3, wherein the dimples are closer to one of said ends.

5. The compression limiter of claim 1, wherein (D1−Dh)>(D3−Dm).

6. A fastener and paired compression limiter, wherein
the fastener has a head, a shank portion of uniform diameter Ds extending from the head and a lead portion including threads extending from the shank and having a maximum diameter Dm; and
the compression limiter comprises a tubular sleeve having a substantially cylindrical wall extending between first and second ends with outside diameter D1 and inside diameter D2>Dm, weakened regions of the wall located such that the wall can be circumferentially compressed radially inwardly, and at least one projection extending radially inwardly from the wall and defining a minimum effective diameter D3, where Ds<Dm<D3<D2.

7. The fastener and paired compression limiter of claim 6, wherein the sleeve surrounds the fastener with the at least one projection at the shank while Dm>D3.

8. The fastener and paired compression limiter of claim 7, wherein the sleeve and fastener form a stand-alone subassembly.

9. The fastener and paired compression limiter of claim 7, wherein the first end of the sleeve is closer than the second to the head of the fastener and the at least one projection is closer to the first end of the sleeve than to the second end.

10. The fastener and paired compression limiter of claim 6, further associated with a component having a round through hole with wall diameter Dh<D1.

11. The fastener and paired compression limiter of claim 10, wherein (D1−Dh)>(D3−Dm).

12. The fastener and paired compression limiter of claim 11, wherein said association includes the lead portion of the fastener aligned within said hole while the sleeve is outside said hole.

13. In an assembled combination, a fastener and a compression limiter in a round hole of wall diameter Dh in a component to be fastened to another component, wherein:
the fastener comprises a head having a bottom with diameter Db, a shank portion of uniform diameter Ds extending from the head and a lead portion including threads extending from the shank and having a maximum diameter Dm, where Ds<Dm<Db;
the compression limiter comprises a tubular sleeve having a substantially cylindrical wall extending between first and second ends, retained by compressive interference within the wall of the hole in the component such that outside diameter D1 of the sleeve wall is at inside diameter Dh of the hole, the inside diameter D2 of the sleeve wall is greater than Dm, and at least one projection extends radially inwardly from the sleeve wall at the shank and defines an effective diameter D3<Dm; and
the bottom of the head at diameter Db>/=D2 prevents the fastener from passing entirely through the sleeve in the direction toward the lead portion and the at least one projection at effective diameter D3<Dm prevents the fastener from passing entirely through the sleeve in the direction toward the head.

14. The assembled combination of claim 13, wherein the first end of the sleeve is closer than the second to the head of the fastener and the at least one protrusion is closer to the first end of the sleeve than to the second end.

15. The assembled combination of claim 14, wherein the hole has a length through the component and the sleeve has a length that is within a difference of +/−3% of the length of the hole.

16. The assembled combination of claim 15, wherein the lead portion of the fastener is threaded along a thread length, and the thread length is substantially equal to the length of the sleeve between the at least one projection and the second end of the sleeve.

17. A method for installing and capturing a fastener within a compression limiter mounted in the hole of a component, comprising:
selecting a fastener having a head, a shank portion of uniform diameter extending from the head and a threaded lead portion extending from and having a greater diameter than the shank portion;
selecting a compression limiter in the form of a tubular sleeve having a substantially cylindrical wall extending between first and second ends;
sliding the sleeve over the leading portion of the fastener onto the shank;
inserting the leading portion of the fastener into the hole;
urging the head of the fastener against the sleeve and thereby driving the sleeve into the hole and mounting the sleeve within the hole by radially inwardly compressing the sleeve;
whereby compressing the sleeve as the sleeve is driven into the hole pushes projections on the inside of the sleeve toward the shank and establishes an effective diameter of the projections at the shank that is smaller than the diameter of the lead portion of the fastener.

18. The method of claim 17, wherein the sleeve is retained by compressive interference within the wall of the hole in the component such that outside diameter D1 of the sleeve wall is at inside diameter Dh of the hole, the inside diameter D2 of the sleeve wall is greater than Dm, and at least one projection extends radially inwardly from the sleeve wall at the shank and defines an effective diameter of D3<Dm.
